(19) United States
(12) Patent Application Publication
(10) Pub. No.: US 2002/0184620 A1
(43) Pub. Date: Dec. 5, 2002

(54) Method and an apparatus for an audiovisual monitoring application for children

(76) Inventors: Nigel Andrew Justin Davies, Hala (GB); Pierre-Guillaume Raverdy, Santa Clara, CA (US)

Correspondence Address: Archana B.Vittal, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/875,417

(22) Filed: Jun. 5, 2001

(51) Int. Cl. H04N 7/16

(52) U.S. Cl. 725/25; 725/27; 725/28

(57) ABSTRACT

A method and an apparatus for an audiovisual (AV) monitoring application for children are described. The AV monitoring system for children includes one or more child devices and a parent device coupled to a network. The parent device has an AV receiver configured to access AV content directed to the child device. The parent device monitors the AV content to determine if the AV content includes a specified content. If the AV content includes a specified content, the parent device generates a warning. The parent device has a display that may display both the warning and the AV content directed to the child device.

### FIELD OF THE INVENTION

The present invention relates generally to audiovisual devices, and more particularly, to an audiovisual monitoring application for children.

### BACKGROUND

Typically, a home audiovisual (AV) system will include a number of devices. These devices may include a number of televisions in different rooms, stereo systems, VCRs, DVD players, radio tuners, computers with internet access etc. Often, members of a single household will have different preferences when it comes to audiovisual entertainment, so each person may utilize a different device. For instance, one parent may be watching a television in the living room while another parent is listening to the stereo in the kitchen. In the meantime, a child may be watching television in his room.

For a parent, constant supervision over the child's use of the AV equipment is difficult to accomplish. Currently, there are a number of devices designed to place limitations on what a child can watch on television. For instance, a parent may place a child lock on designated channels in order to prevent the child from viewing those channels. However, it is often difficult to prevent the child from watching or listening to programs with explicit material or adult content. For instance, a child may watch a documentary on a network television channel during primetime about the civil war. Since the channel is a network channel and the child is watching during prime time hours, the parent is unlikely to have placed a lock on the channel. However, a television program on the civil war may show graphic imagery not suitable for children.

Another example may be explicit lyrics that are present in some popular music today. Parents do not have a remedy for blocking music containing explicit lyrics played by their children that can be accessed from the internet, for example. Unless the parents physically walk into the room where the children are utilizing the AV equipment, the parents cannot fully monitor their children's use of home AV equipment. Therefore, an application is needed where parents are able to monitor the AV activity of their children.

### SUMMARY OF THE INVENTION

Accordingly, a method and an apparatus for an audiovisual (AV) monitoring application for children are given. The AV monitoring system for children includes one or more child devices and a parent device coupled to a network. The parent device has an AV receiver configured to access AV content directed to the child device. The parent device monitors the AV content to determine if the AV content includes a specified content. If the AV content includes a specified content, the parent device generates a warning. The parent device has a display that may display both the warning and the AV content directed to the child device.

### BRIEF DESCRIPTION OF THE DRAWINGS

The present invention is illustrated by way of example, and not limitation, in the figures of the accompanying drawings in which:

FIG. 1 illustrates a diagrammatic representation of a machine in the exemplary form of a computer system;

FIG. 2 illustrates one embodiment of a home audiovisual system with an AV monitoring application for children;

FIG. 3 illustrates one embodiment of a controller having an AV monitoring application for children;

FIG. 4a illustrates one embodiment of a AV monitoring application for children in a home audio/visual initiative (HAVI) network;

FIG. 4b illustrates an exploded view of the second device shown in FIG. 4a;

FIG. 4c illustrates an exploded view of the second device and the IP device shown in FIG. 4a;

FIG. 4d illustrates an exploded view of the second device and the IP device shown in FIG. 4a; and

FIG. 5 shows a flow diagram of one embodiment of a process of monitoring audiovisual (AV) content on a child device using a parent device.

### DETAILED DESCRIPTION

A method and an apparatus for an audiovisual (AV) monitoring application for children are disclosed. Reference will now be made in detail to the embodiments of the invention, examples of which are illustrated in the accompanying drawings. While the invention will be described in conjunction with numerous embodiments, it will be understood that they are not intended to limit the invention to these embodiments. On the contrary, the invention is intended to cover alternatives, modifications and equivalents, which may be included within the spirit and scope of the invention as defined by the claims.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

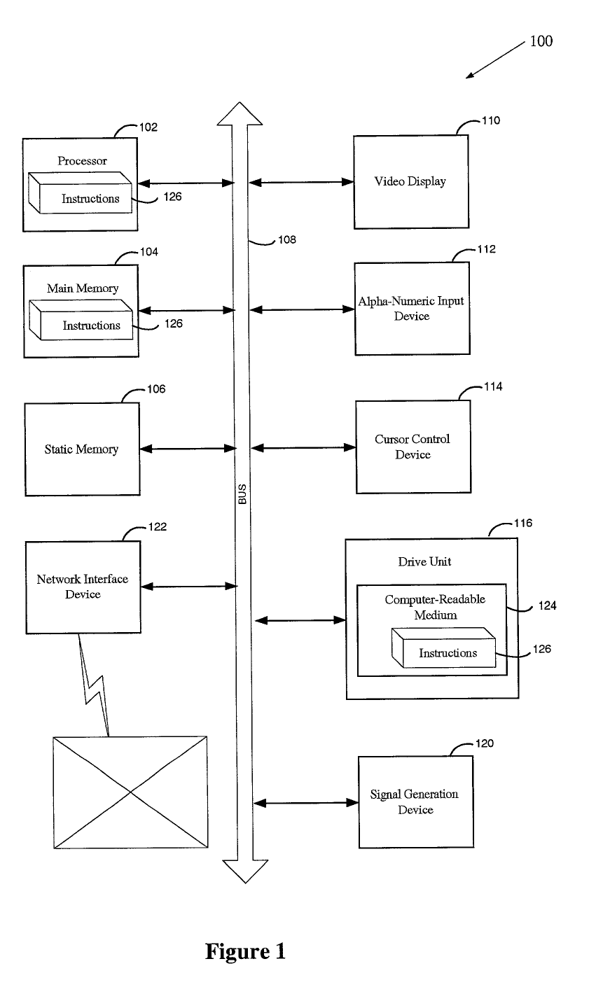

FIG. 1 illustrates a diagrammatic representation of machine in the exemplary form of a computer system 100 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alpha-numeric input device 112 (e.g., a keyboard), a cursor control device 114 (e.g., a mouse), a disk drive unit 116, a signal generation device 120 (e.g., a speaker) and a network interface device 122.

The disk drive unit 116 includes a computer-readable medium 124 on which is stored a set of instructions (i.e., software) 126 embodying any one, or all, of the methodologies described above. The software 126 is also shown to reside, completely or at least partially, within the main memory 104 and/or within the processor 102. The software 126 may further be transmitted or received via the network interface device 122. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, and carrier wave signals.

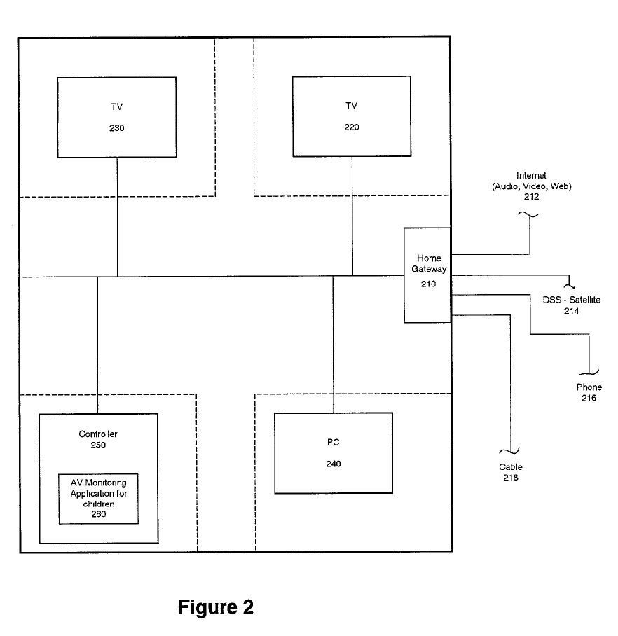

FIG. 2 illustrates one embodiment of a home audiovisual system with an AV monitoring application for children. In a home audiovisual (AV) network, a home gateway 210 may include multiple AV feeds into the house. Examples of some feeds are shown in FIG. 2. There may be an internet feed 212, a direct satellite system (DSS) satellite feed 114, a phone feed 216, and a cable feed 218. The cable feed 218 may be a digital subscriber line (DSL). These feeds allow AV content to be displayed on different AV equipment in the house.

In the embodiment shown in FIG. 2, there are two televisions 220 and 230 in different rooms, and a personal computer (PC) 240 in a separate room. A parent may want to monitor a child watching the television 220 or using the PC 240 in one room while the parent is in another room. In this embodiment, a device used by the parent may act as controller 250. The controller 250 having an AV monitoring application for children 260 is able to monitor the AV content directed to either the televisions 220 and 230 or the PC 240 in different room. In alternative embodiments, there may be other AV equipment that may be monitored.

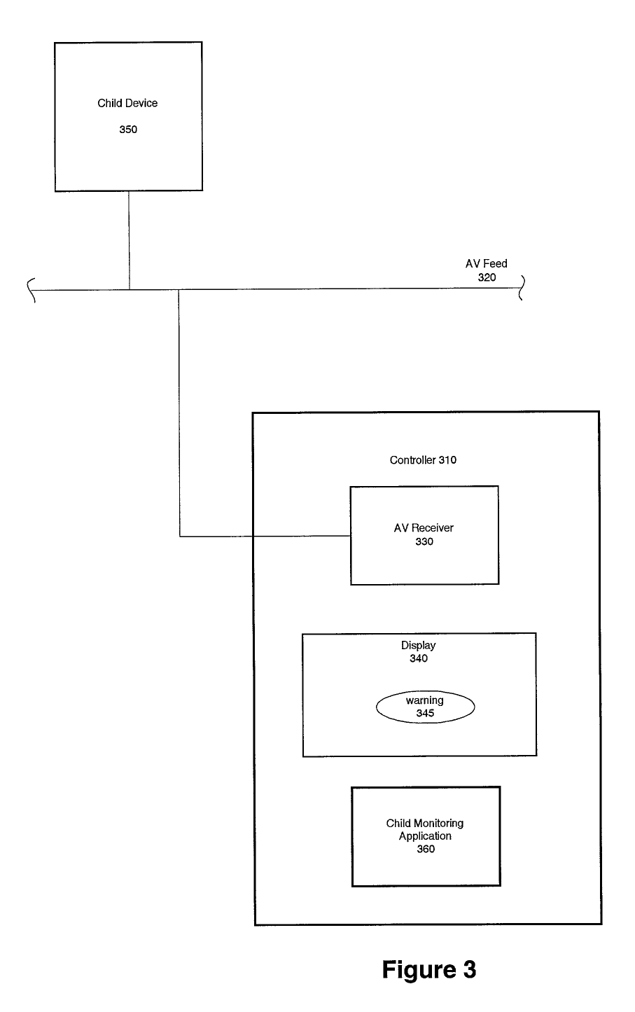

FIG. 3 illustrates one embodiment of a controller 310 having an AV monitoring application for children 360. The AV monitoring application for children 360 allows the controller 310 to access and receive AV content 320 directed to another AV device being used by the child (child device) utilizing an AV receiver 330. The controller 310 is configured to monitor and review the AV content 320 directed to the child device to determine if the AV content 320 includes at least one specified content. If the controller 310 determines that the child is watching a device receiving AV content 320 having that specified content, the controller 310 is configured to generate a warning 345. In this embodiment, the controller 310 has a display 340 to display both the warning 345 and the AV content 320 directed to the child device. In an alternative embodiment, the controller may also generate a warning for event changes in the child device. For example, if the child changes the channel on the television, the AV monitoring application for children prompts the controller to display that event change on the display for the parent.

In one embodiment, the controller includes a user interface. The user interface allows the parent to input one or more specified content. The specified content may include, but is not limited to, explicit lyrics, explicit topics, or program titles. The controller monitors the AV content directed to the child device and warns the parent when the child is viewing AV content that includes the specified content.

In one embodiment, the controller may be another PC. In an alternative embodiment, the controller may be a personal digital assistant (PDA). In other alternative embodiments, the controller may be another device having the capabilities necessary to be a controller. A device should have certain connection capabilities in order to function as a controller. A controller may have a cable connection and/or internet protocol (IP) connection to monitor cable television and internet activities. A device should also have a certain amount of processing power and central processing memory in order to function as the controller. The controller is capable of identifying an AV stream as well as the source and sink of the AV stream.

In one embodiment, the AV monitoring application for children may be downloaded from the internet to the controller. In an alternative embodiment, the AV monitoring application may be bought separately and manually installed on any device capable of acting as a controller. In another alternative embodiment, the AV monitoring application may come bundled with a device such as a personal digital assistant (PDA).

In one embodiment, the AV monitoring application for children may be integrated with an electronic program guide. Accordingly, a parent may obtain more information on the programs the children are watching before or after receiving a warning about the AV content of those programs. In an alternative embodiment, the AV monitoring application for children may also include a control functionality enabling parents to block certain channels.

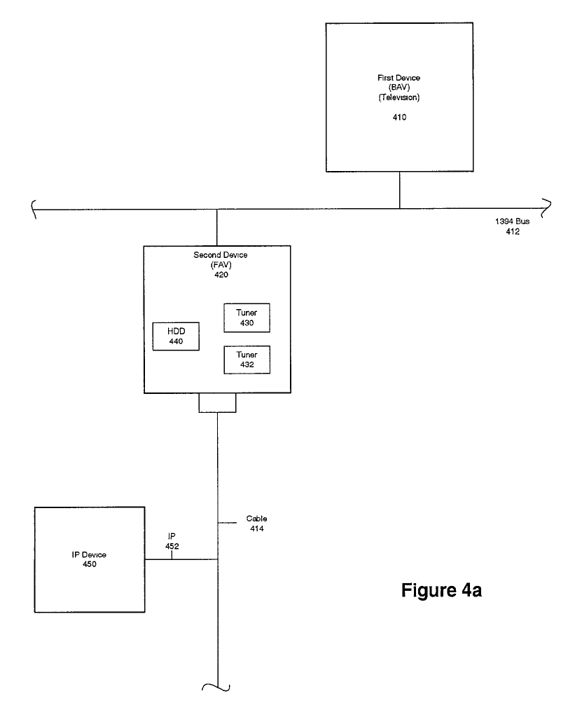

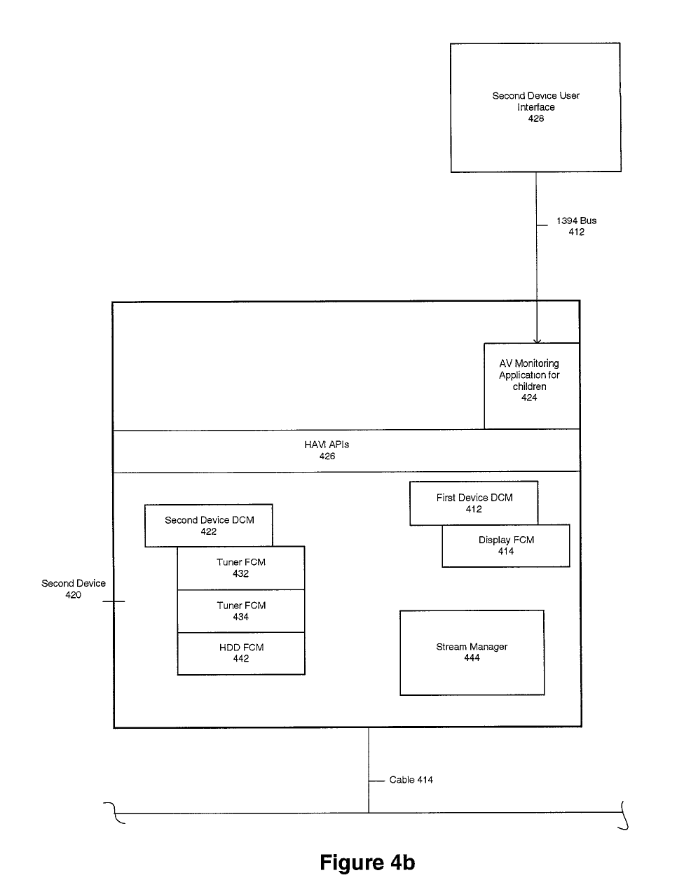

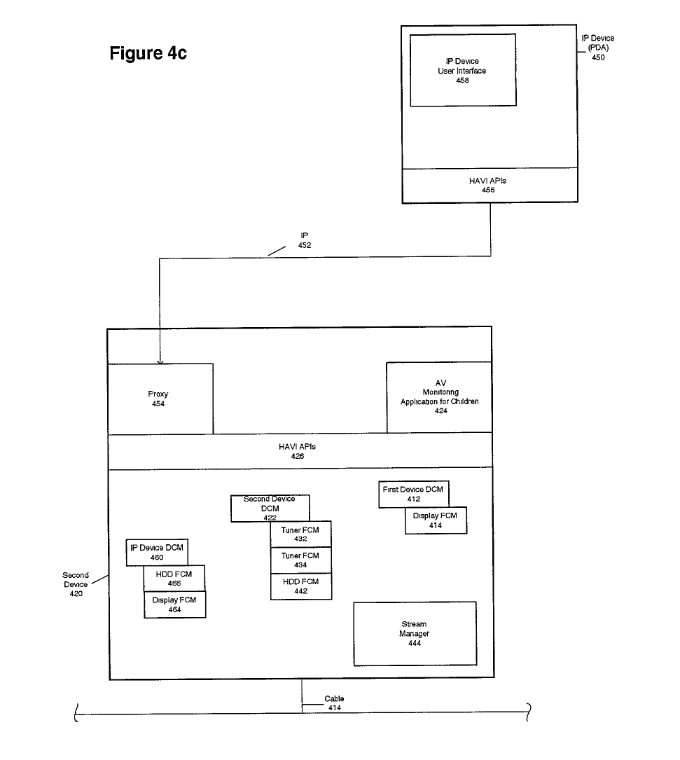

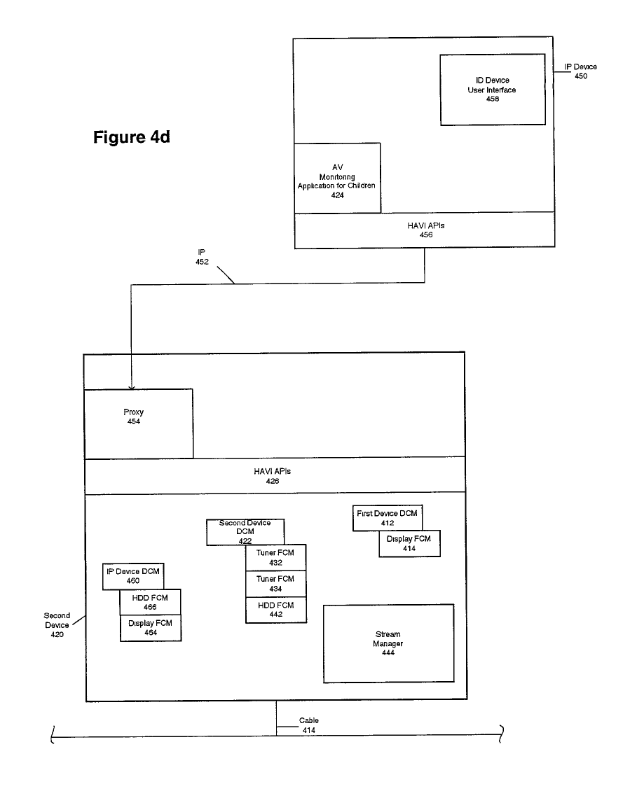

FIG. 4a illustrates one embodiment of a AV monitoring application for children in a home audio/visual initiative (HAVI) network. HAVI is a digital AV networking initiative that provides a home networking software specification for seamless interoperability among home entertainment products. The HAVI specification actually defines a set of criteria that enables compliant AV devices to interoperate in a home network. The specification lays down application program interfaces, APIs, which can be used by programmers to build applications that run on such networks, controlling devices irrespective of vendor or specific model characteristics.

The HAVI network has been used increasingly to provide seamless interoperability between home AV devices. The underlying structure includes a set of interconnected clusters of appliances. Each cluster will work as a set of interconnected devices to provide a set of services to users. Often, one device will act as a controller for a set of other devices.

Generally, the interoperability model in HAVI provides (1) support for existing devices; (2) a default control model; (3) means to extend the default control model when new devices or functionality are brought to market; and (4) a common means for device representation. To achieve the above, the HAVI architecture defines three types of nodes in the home network: Full AV nodes (FAV), Intermediate AV nodes (IAV) and Base AV nodes (BAV). Further detail about the HAVI network including the notation and nomenclature, architecture overview, and a system model of a HAVI network are described in U.S. Pat. No. 6,085,236, filed on Jan. 6, 1999, commonly assigned herewith and incorporated herein by reference.

The interconnection medium used in a HAVi network is Institute of Electrical and Electronic Engineers (IEEE) 1394. The IEEE 1394 serial communication bus standard (1394) is used as a local bus platform to provide the common messaging system. It carries commands and status information as well as digital audio and digital video signals between devices.

In the embodiment shown in FIG. 4a, a first device 410 and a second device 420 are coupled to a HAVI network via a IEEE 1394 bus 412. The first device 410 is a BAV device in this embodiment, and the second device is a FAV device. An FAV node is a device that contains a complete instance of the AV software model. This type of node generally has a richer set of resources and is capable of supporting a complex software environment. The primary distinguishing feature of an FAV node is that it is able to take control responsibility for less sophisticated devices and does this by loading a control module, usually from the less sophisticated device, and executing it locally. In this embodiment, the second device also has a cable connection 414 and is coupled to an IP device 450 via an IP protocol 452.

In this embodiment, first device 410 is a television being watched by the child in one room while the second device 420 is a PC being used by the parent in another room. The second device 420 has two tuners 430 and 432 and a hard disk device (HDD) 440. The IP device 450 may be a personal digital assistant (PDA) used by a parent in a location away from the first device 410.

FIG. 4b illustrates an exploded view of the second device 420 shown in FIG. 4a. The second device 420 includes HAVI automated programming interfaces (APIs) 426 that allow the second device 420 to communicate with other HAVI compliant devices such as the first device 410 via a communication medium such as the IEEE 1394 bus 412.

In different embodiments, the HAVI APIs have a library of functions. In one embodiment, the HAVI APIs may include Java and C++ HAVI/IP Management APIs. In another embodiment, the HAVI APIs may include Java and C++ HAVI APIs and Java and C++ HAVI/IP Management APIs. In yet another embodiment, the HAVI APIs may include the two mentioned as well as Custom Java Media Framework (JMF) data sources and sinks.

The second device 420 creates device control modules (DCMs) and functional control modules (FCMs) for each device on the HAVI network. In the embodiment shown in FIG. 4b, the second device 420 instantiates a second device DCM 422 and a first device DCM 412. A DCM is a logical representation of a device that provides an API used to send control commands to that device by the second device 420. The second device also instantiates two tuner FCMs 432 and 434 and an HDD FCM 442 for the second device and a display FCM 414 for the first device.

In the embodiment of FIG. 4b, the AV monitoring application 424 may be either installed or downloaded into the second device 420. The AV monitoring application for children 424 allows a parent to use the second device user interface 428 to input specified content that the second device 420 will watch for in the AV content directed toward the first device 410. The AV monitoring application 424 will use the HAVI APIs 426 to communicate with the stream manager 444 to get information about the established streams that are directed to the first device 410. Then, the AV monitoring application 424 will get additional information about the content that is being streamed. If it is determined that the AV stream has content that the parents want to be filtered, the specified content, the AV monitoring application for children 424 will generate a warning to the parent or display the AV content being watched by the child.

FIG. 4c illustrates an exploded view of the second device 420 and the IP device 450 shown in FIG. 4a. In this embodiment, the IP device 450 may be a personal digital assistant (PDA) used to monitor the AV content directed to the first device. The AV monitoring application for children 424 is manually installed or downloaded into the second device (FAV) 420. In this embodiment, the second device 420 also includes a proxy 454 that communicates with the IP device 450 using an IP protocol 452. Further detail about one approach of the integration of an IP device into a HAVi network including the notation and nomenclature, architecture overview, and system model of a IP and HAVi network are described in U.S. Patent Application, titled, “METHOD AND APPARATUS FOR THE INTEGRATION OF IP DEVICES INTO A HAVI NETWORK”, having common inventorship herewith and incorporated herein by reference.

In this embodiment, the parent may use the IP device user interface 458 to input the specified content. The IP device 450 also includes an application program interface (API) 456 that allows the IP device 450 to translate and relay calls to and from devices coupled to the HAVI network such as the second device 420. The APIs 456 assist IP devices in hosting HAVI applications. In this embodiment, the second device 420 instantiates an IP DCM 460 and corresponding FCMs, Display 464 and HDD 466 to represent the IP device 450. The proxy 454 redirects commands and streams between the IP device 450 and other devices that are a part of a 1394 based HAVi network. The parents can choose to have the warnings or AV content displayed on the IP device (PDA) 450. In that case, the AV monitoring application 424 accesses the IP device DCM 460 and FCMs 466 and 464, and warnings or content are redirected by the proxy 454. Accordingly, in this embodiment, a parent may monitor the AV content directed to the first device 410 (child device) via a mobile IP device 450 from anywhere in the house or from a point outside of the house such as an office.

FIG. 4d illustrates an exploded view of the second device 420 and the IP device 450 shown in FIG. 4a. In this embodiment, the second device 420 and IP device 450 are similar to the second device 420 and IP device 450 shown in FIG. 4c. However, in this embodiment, the AV monitoring application for children 424 may be downloaded or installed on the IP device 450 itself rather than on the second device 420.

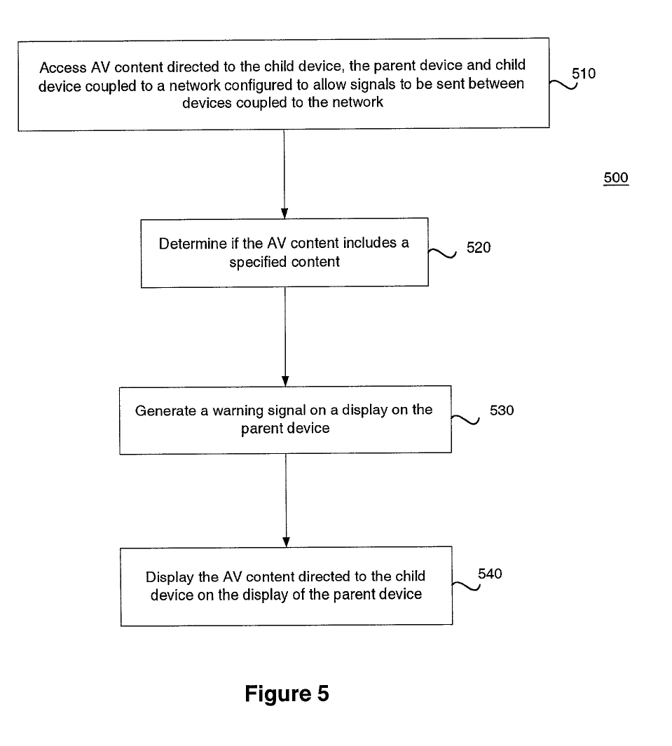

FIG. 5 shows a flow diagram for one embodiment of a process 500 of monitoring audiovisual (AV) content on a child device using a parent device. In step 510, AV content directed to the child device is accessed by the parent device. The parent and child devices are both coupled to a network configured to allow signals to be sent between devices coupled to that network. In step 520, it is determined if the AV content includes a specified content inputted by the parents. In step 530, if the specified content is included in the AV content, a warning signal is generated on a display of the parent device. In step 540, the AV content directed to the child device is displayed on the display of the parent device.

A method and an apparatus for a AV monitoring application for children has been described. Although the present invention has been described with reference to specific embodiments, the specification and drawings are to be regarded as illustrative rather than restrictive.

What is claimed is:

1. An audiovisual (AV) monitoring application for children on a parent controller device comprising an AV receiver on the parent controller device configured to access and receive AV content directed to at least one child device, the parent controller device configured to monitor and review the AV content directed to the child device to determine if the AV content includes at least one specified content, the parent controller device configured to generate a warning when the AV content including the specified content is being actively sent to the child device.

2. The AV monitoring application for children of claim 1 further comprising a display on the parent controller device configured to display both the warning and the AV content directed to the child device.

3. The AV monitoring application for children of claim 2 further comprising a user interface configured to allow a user to input the specified content.

4. The AV monitoring application for children of claim 3 wherein the specified content is chosen from the group consisting of: explicit lyrics, explicit topics, or program titles.

5. The AV monitoring application for children of claim 1 wherein the AV receiver is configured to receive and display AV content directed to the parent controller device concurrently with AV content directed to the child device.

6. The AV monitoring application for children of claim 1 further comprising a network, the child device and the parent controller device coupled to the network.

7. The AV monitoring application for children of claim 6 wherein the network is a home audio/visual initiative (HAVI) network.

8. The AV monitoring application for children of claim 7 wherein the child device is a HAVI compliant device.

9. The AV monitoring application for children of claim 8 wherein the parent controller device is a HAVI compliant device.

10. The AV monitoring application for children of claim 9 wherein the parent controller device is a full audiovisual node (FAV) device.

11. The AV monitoring application for children of claim 1 further comprising:
at least one child device coupled to a home audio/visual initiative (HAVI) network; and
a HAVI compliant parent device coupled to the HAVI network and acting as the parent controller device.

12. A parent controller device comprising:
an AV receiver configured to access AV content directed to at least one child device
an audiovisual (AV) monitoring application for children that allows the parent controller device to monitor the AV content directed to the child device to determine if the AV content includes at least one specified content; and
a display to generate a warning when the AV content including the specified content is being actively sent to the child device.

13. The parent controller device of claim 12 wherein the display is configured to display both the warning and the AV content directed to the child device.

14. The parent controller device of claim 12 further comprising a user interface configured to allow a user to input the specified content.

15. The parent controller device of claim 14 wherein the specified content is chosen from the group consisting of: explicit lyrics, explicit topics, or program titles.

16. The parent controller device of claim 12 wherein the AV receiver is configured to receive and display AV content directed to the parent controller device concurrently with AV content directed to the child device.

17. The parent controller device of claim 12 wherein the parent controller device and the child device are coupled to a network.

18. The parent controller device of claim 17 wherein the network is a home audio/visual initiative (HAVI) network.

19. The parent controller device of claim 18 wherein the child device is a HAVI compliant device.

20. The parent controller device of claim 19 wherein the parent controller device is a HAVI compliant device.

21. The parent controller device of claim 20 wherein the parent controller device is a full audiovisual node (FAV) device.

22. A method of monitoring audiovisual (AV) content on a child device using a parent controller device comprising:
accessing AV content directed to the child device by the parent controller device;
determining if the AV content includes a specified content; and
generating a warning on a display on the parent controller device when the AV content includes the specified content.

23. The method of claim 22 further comprising displaying the AV content directed to the child device on the display of the parent controller device.

24. The method of claim 23 further comprising the step of inputting the specified content on a user interface of the parent controller device.

25. The method of claim 24 wherein specified content is chosen from the group consisting of: explicit lyrics, explicit topics, or program titles.

26. The method of claim 23 further comprising displaying AV content directed to the parent controller device on the display of the parent controller device concurrently with the AV content directed to the child device.

27. A computer readable medium comprising instructions, which when executed on a processor, perform a method for compressing data, the method comprising:
accessing AV content directed to the child device by the parent controller device;
determining if the AV content includes a specified content; and
generating a warning on a display on the parent controller device when the AV content includes the specified content.
